(19) United States
(12) Patent Application Publication
(10) Pub. No.: US 2005/0278469 A1
(43) Pub. Date: Dec. 15, 2005

(54) Computer system and control method of the same

(75) Inventor: Joong-yup Yi, Daegu city (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/144,733

(22) Filed: Jun. 6, 2005

(30) Foreign Application Priority Data
Jun. 11, 2004 (KR) 2004-43216
Apr. 12, 2005 (KR) 2005-30467

(51) Int. Cl. G06F 13/00

(52) U.S. Cl. 710/301

(57) ABSTRACT

A computer system including an external card having a first interface or a second interface, to communicate with the computer system via the first interface or the second interface; a card-mounting part to provide each of interface parts supporting the first interface and the second interface and to mount the external card; a signal generator generating a signal for determining whether the external card supporting the first interface is mounted; and a controller to interrupt a signal output from the signal generator when the external card supporting the second interface is mounted. Thus the computer system and control method of the same can reduce wasteful loss of electric power.

### CROSS-REFERENCE TO RELATED APPLICATIONS

This application claims the benefit of Korean Patent Application No. 2004-43216, filed on Jun. 11, 2004 and Korean Patent Application No. 2005-30467, filed on Apr. 12, 2005 in the Korean Intellectual Property Office, the disclosures of which are incorporated herein by reference.

### BACKGROUND OF THE INVENTION

1. Field of the Invention

An aspect of the present invention relates to a computer system, and a control method thereof, and more particularly, to a computer system and a control method thereof which can reduce wasteful loss of electric power.

2. Description of the Related Art

Computer systems are rapidly developing. For example, an Express card is substituting a personal computer memory card international association (PCMCIA) card and is being employed as a memory or an input/output device having a size suitable for a notebook computer or a laptop computer. Today, there is no suitable application available for using the Express card, so it is difficult to adapt the Express card to the computer system. However, it is expected that the Express card will replace the PCMCIA card and that the Express card will be employed in the computer system when an application compatible with the entire PCMCIA card appears.

Such an Express card has a universal serial bus (USB) interface or a peripheral component interconnect (PCI)-Express interface. The Express card is mounted into a card-mounting part with an USB/PCI-Express interface provided in the computer system, and communicates with the computer system via the related interface of the Express card.

Here, the computer system periodically generates a predetermined clock signal “PCI-E CLK” and a PCI interface signal via the card-mounting part for determining whether the Express card supporting the PCI-Express interface is mounted or not.

Hereinafter, the connection of the Express card with each of the interfaces will be described in more detail. When the Express card supporting the PCI-Express interface is connected to a PCI-Express terminal of the card-mounting part, the computer senses the mounting of the Express card supporting the PCI-Express interface according to the predetermined clock signal “PCI-E CLK” and the PCI interface signal, and communicates with the Express card via the card-mounting part. Further, when the Express card supporting the USB interface is connected to an USB terminal of the card-mounting part, the Express card outputs a voltage signal of a predetermined level which indicates the mounting of the card via a predetermined signal pin of the USB terminal of the card-mounting part, and the computer system communicates with the Express card via the USB interface in response to the electric signal.

However, the conventional computer system continuously generates the clock signal “PCI-E CLK” and the PCI-Express interface signal via the PCI-Express terminal of the card-mounting part for determining whether the Express card supporting the PCI-Express interface is mounted or not. Therefore, electric power is wasted.

### SUMMARY OF THE INVENTION

Accordingly, it is an aspect of the present invention to provide to a computer system and a control method thereof that can reduce wasteful loss of electric power.

The foregoing and/or other aspects of the present invention are also achieved by providing a computer system including an external card having a first interface or a second interface, to communicate with the computer system via each interface; a card-mounting part to provide each of interface parts supporting the first interface and the second interface and to mount the external card; a signal generator generating a signal for determining whether the external card supporting the first interface is mounted; and a controller to interrupt a signal output of the signal generator when the external card supporting the second interface is mounted.

According to an aspect of the present invention, the signal generator may include a clock signal generator outputting a clock signal to the external card mounted into the card-mounting part.

According to another aspect of the present invention, the external card may include an Express card communicating via either a USB interface or a PCI-Express interface; the first interface may include the PCI-Express interface and the second interface may include the USB interface; and the interface parts of the card-mounting part may include a PCT-Express interface part and a USB interface part respectively.

According to another aspect of the present invention, the computer system may further include a card sensor determining whether a USB Express card communicating via the USB interface is mounted into the card-mounting part; wherein the controller prevents the clock signal generator from outputting a PCI-Express clock signal corresponding to the PCI-Express interface part and prevents an PCI-Express interface signal corresponding to the PCI-Express interface part from being outputted when the USB Express card is mounted into the card-mounting part according to a sensing signal from the card sensor.

According to another aspect of the present invention, the controller may include an ICH (input/output control hub) to continuously output the PCI-Express interface signal to the PCI-Express interface part, and to control the clock signal generator.

According to another aspect of the present invention, the ICH may output a USB mounting signal informing that the USB Express card is connected, and control the clock signal generator preventing the output of the PCI-Express clock signal and preventing the PCI-Express interface signal from being outputted corresponding to a predetermined control signal when the USB Express card is mounted into the card-mounting part according to the sensing signal.

According to another aspect of the present invention, the controller may include a BIOS (basic input/output system) to output an interrupt control signal prevent the output of the PCI-Express clock signal and the PCI-Express interface signal to the ICH if the BIOS receives the USB mounting signal from the ICH, and determines that the PCI-Express interface part is not used.

According to another aspect of the present invention, the ICH may control the clock signal generator to output a USB clock signal corresponding to the USB interface part and to output the USB interface signal corresponding to the USB interface part to the USB Express card when the USB Express card is mounted into the card-mounting part according to the sensing signal.

According to another aspect of the present invention, the card sensor may include a predetermined signal pin outputting a card mounting signal inputted from the USB Express card to the ICH if the USB Express card is mounted into the card-mounting part, among a plurality of signal pins provided in the USB interface part.

According to another aspect of the present invention, the clock signal generator may output either the USB clock signal or the PCI-Express clock signal according to the output of the ICH.

According to another aspect of the present invention, the card sensor may include a predetermined signal pin outputting a card mounting signal inputted from the USB Express card to the ICH if the USB Express card is mounted into the card-mounting part, among a plurality of signal pins provided in the USB interface part.

According to another aspect of the present invention, the clock signal generator may output either the USB clock signal or the PCI-Express clock signal according to the control of the ICH.

The foregoing and/or other aspects of the present invention are also achieved by providing a control method of a computer system including a card-mounting part to provide each of interface parts supporting a first interface and a second interface and to mount the external card communicating via the first interface or the second interface, and a signal generator to generate a signal for determining that the external card supporting the first interface is mounted, the method including mounting the external card into the card-mounting part; sensing whether the external card supporting the second interface is connected to a second interface part of the interface parts; preventing a signal of the signal generator from being outputted, when the external card supporting the second interface is mounted.

According to another aspect of the present invention, the external card may include an Express card communicating via either a USB interface or a PCI-Express interface; the first interface includes the PCI-Express interface, and the second interface includes the USB interface; and a first interface part of the interface parts includes a PCI-Express interface parts, and the second interface part thereof includes a USB interface part.

According to another aspect of the present invention, the sensing may include sensing whether the USB Express card communicating via the USB interface is connected to the USB interface part of the card-mounting part.

According to another aspect of the present invention, the signal generator may include a clock signal generator outputting either the USB clock signal or the PCI-Express clock signal to the external card mounted into the card-mounting part; and the computer system further includes an ICH (input/output control hub) to control the clock signal generator part and continuously output the PCI-Express interface to the PCI-Express interface part, and a BIOS; the preventing of the signal of the signal generator from being outputted includes outputting a USB mounting signal to the BIOS by the ICH, when the USB Express card is mounted into the card-mounting part according to the sensing, and outputting a interrupt control signal to the ICH by the BIOS, when the BIOS receives the USB mounting signal and determines that the PCI-Express interface part is not used.

According to another aspect of the present invention, the preventing of the signal of the signal generator from being outputted includes: preventing the PCI-Express clock signal from being outputted as controlling the clock signal generator controlled by the ICH according to the interrupt control signal, and preventing the PCI-Express interface signal from being outputted by the ICH.

According to another aspect of the present invention, a control method of a computer system further including controlling the clock signal generator to output a USB clock signal by the ICH and outputting the USB interface signal by the ICH, when the USB Express card is mounted into the card-mounting part as the result of the sensing.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a control block diagram of a computer system according to an embodiment of the present invention;

FIG. 2 is a control flowchart of the computer system according to the embodiment of the present invention;

FIG. 3 is a view illustrating a signal flow when an Express card is not mounted in the computer system according to the embodiment of the present invention;

FIG. 4 is a view illustrating a signal flow when a USB Express card communicating via a PCI-Express interface is mounted in the computer system according to the embodiment of the present invention; and

FIG. 5 is a view illustrating a signal flow when an PCI-Express card communicating via a PCI-Express interface is mounted in the computer system according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

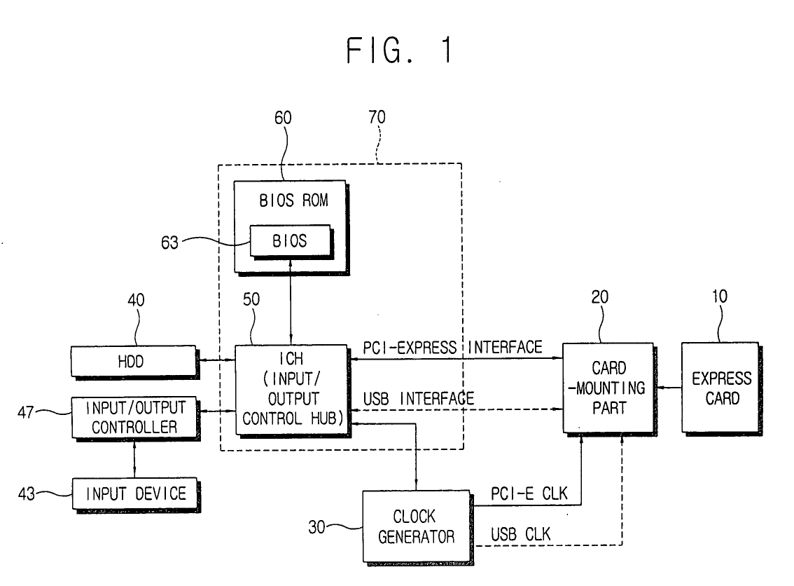

FIG. 1 is a control block diagram of a computer system according to an embodiment of the present invention. As shown therein, the computer system according to an embodiment of the present invention includes an Express card 10 having either a USB interface or a PCI-Express interface; a card-mounting part 20 to mount the Express card 10 including a plurality of interface parts (not shown) supporting an interface of the Express card 10; a clock signal generator 30 to supply a clock signal to the Express card 10 via the card-mounting part 20; and a controller 70 preventing the clock signal generator 30 from outputting the clock signal “PCI-E CLK” for the PCI-Express interface, at the same time preventing a PCI-Express interface signal from being outputted when the USB interface is used to communicate with the Express card 10 mounted into the card-mounting part 20.

The Express card 10 includes the USB interface or the PCI-Express interface, is mounted into the card-mounting part 20 with the USB/PCI-Express interface part provided in the computer system, and communicates with the controller 70 via the related interface of the Express card 10.

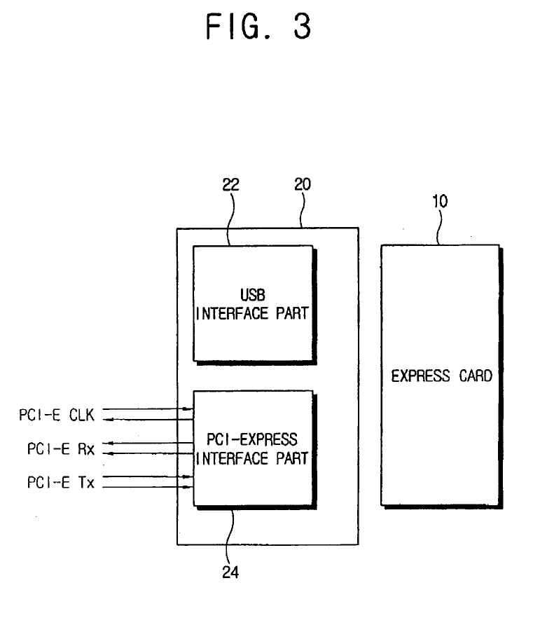

The card-mounting part 20 has a USB interface part 22 and a PCI-Express interface part 24, referring to FIG. 3, mounts the Express card 10 for communicating to either the USB interface part 22 or the PCI-Express interface part 24. Herein, a predetermined signal pin among a plurality of signal pins provided in the USB interface part 22 receives a USB signal as a card mounting signal outputted from the Express card 10 supporting the USB interface mounted into the card-mounting part 20 and outputs the USB signal to the controller 70. Therefore, the predetermined signal pin functions as a card sensor (not shown).

Further, the card sensor (not shown) may be changed if the configuration of the card sensor determines that the Express card 10 supporting the USB interface mounted into the card-mounting part 20 is connected to the USB interface part 22 or not. Therefore, the card sensor (not shown) may include a switch (not shown) determining whether the Express card 10 supporting the USB interface is mounted into the card-mounting part 20 or not. Further, the card sensor may include a sensor pin (not shown) respectively provided in the USB interface part 22 for receiving the USB signal and outputting the received USB signal to the controller 70.

According to a control of the controller 70, the clock signal generator 30 outputs the clock signal “PCI-E CLK” or “USB CLK” corresponding to each interface to the Express card 10 via the USB interface part 22 and the PCI-Express interface part 24 provided in the card-mounting part 20, or interrupts the output.

The controller 70 outputs the PCI-Express interface signal to the PCI-Express interface part 24, and includes an ICH (input/output control hub) 50 to control the clock signal generator 30 and a BIOS 63 stored in a BIOS ROM (basic input/output system read only memory) 60.

Hereinafter, an operation of the ICH 50 and the bios 63 of the controller 70 will be described in more detail with reference to FIGS. 3 through 5.

The ICH 50 connects the input signals among various components such as the Hard disk drive (HDD) 40, the input/output controller 47 processing the signal inputted through the input device 43, etc. in the computer system.

As illustrated in FIG. 3, when the Express card 10 is not mounted into the card-mounting part 20, the ICH 50 continuously outputs the clock signal “PCI-E CLK” and the PCI-Express interface signal “PCI-E TX” via the PCI-Express interface part 24 for determining whether the Express card supporting the PCI-Express interface is connected or not. When the Express card 10 is not mounted into the card-mounting part 20, the ICH 50 continuously outputs the PCI-Express interface signal “PCI-E TX” to the PCI-Express interface part 24 corresponding to the sensor signal from the card sensor part (not shown). Further, when the Express card 10 is not mounted into the card-mounting part 20, the ICH 50 controls the clock signal generator 30 so as to output PCI-Express clock signal “PCI-E CLK”.

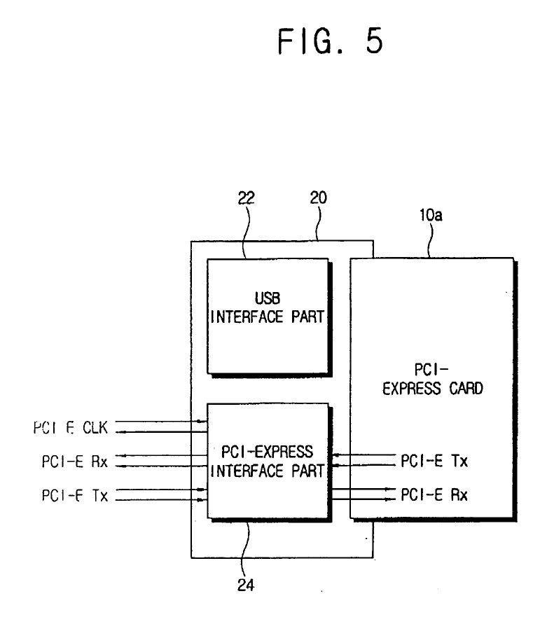

Herein, as illustrated in FIG. 5, if the PCI-Express card 10a supporting the PCI-Express interface is mounted into the card-mounting part 20, the PCI-Express card 10a inputs a PCI-Express interface signal “PCI-E RX” to the ICH 50 via the PCI-Express interface part 24 in response to the PCI-Express interface signal “PCI-E TX” continuously outputted from the ICH 50. The ICH 50 determines that the PCI-Express card 10a is mounted in the card-mounting part 20 by receiving the PCI-Express interface signal “PCI-E RX”. Therefore, the ICH 50 communicates with the PCI-Express card 10a via the PCI-Express clock signal “PCI-E CLK” and the PCI-Express interface signal “PCI-E TX and RX” which are outputted through the PCI-express interface part 24 before the Express card 10a is mounted into the card-mounting part 20.

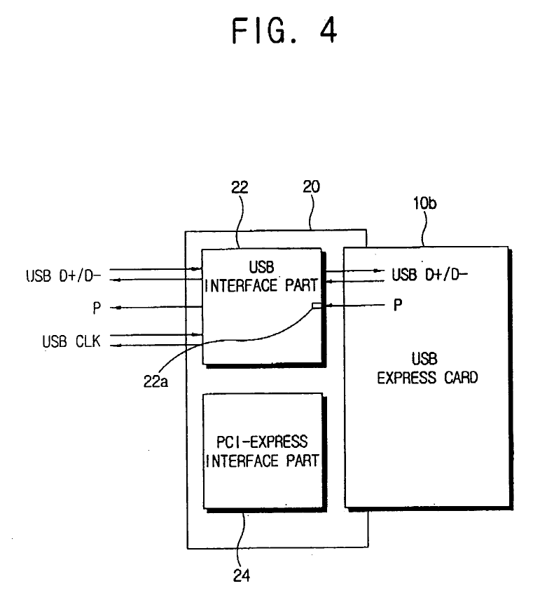

Further, as illustrated in FIG. 4, when the Express card 10b supporting the USB interface is mounted into the card-mounting part 20 and connected to the USB interface part 22, the Express card 10b outputs a USB signal “P” to the ICH 50 via the predetermined signal pin 22a using the card sensor part (not shown) provided in a USB interface part 22. Herein, it is preferred, but not necessary, that the USB signal “P” be a voltage signal of a predetermined level.

Therefore, the ICH 50 receives the USB signal “P”, determines that the USB Express card 10b is mounted into the card-mounting part 20 and connected to the USB interface part 22, and outputs a USB mounting signal to the BIOS 63 to inform this connection.

If the BIOS 63 receives the USB mounting signal from the ICH 50, and then determines that the PCI-express interface part 24 is not used, the BIOS 63 outputs an interrupt control signal preventing the output of the PCI-Express clock signal “PCI-E CLK” and the PCI-Express interface signal “PCI-E TX” to the ICH 50.

Therefore, according to the interrupt control signal, the ICH 50 controls the clock signal generator 30 so as to interrupt an operation outputting the PCI-Express clock signal “PCI-E CLK” to the PCI-Express interface part 24, and interrupts an operation outputting of the PCI-Express interface signal “PCI-E TX” which is continuously outputted to the PCI-Express interface part 24.

Further, when the ICH 50 determines that the USB Express card 10b is connected to the USB interface part 22, the ICH 50 controls the clock signal generator 30 so as to output the USB clock signal “USB CLK” to the USB interface part 22, and outputs the USB interface signal “USB D+/D−” to the USB interface part 22 and communicates with the USB Express card 10b.

Therefore, according to an aspect of the present invention, when the USB Express card 10b is mounted into the card-mounting part 20, the computer system communicates with the USB Express card 10b via the USB interface, and interrupts the output operation of the PCI-Express clock signal “PCI-E CLK” and the PCI-Express interface signal “PCI-E TX” which is continuously generated to communicate with the PCI-Express card 10a.

Here, the PCI-Express interface according to an aspect of the present invention, substitutes the PCI interface used for interchip/device connection, and makes higher-speed communication possible as compared with the PCI interface in an interconnection system between devices mounted to an expansion slot. Further, the PCI-Express interface has the following advantages: the clock signals for communication can be different according to the devices; communication with various devices can be performed at the same time; and communication is performed according to priority of the device. Particularly, the PCI-Express interface supports a hot-swappable function, so that the device being operated while a personal computer is operated can be installed to/removed from the computer system.

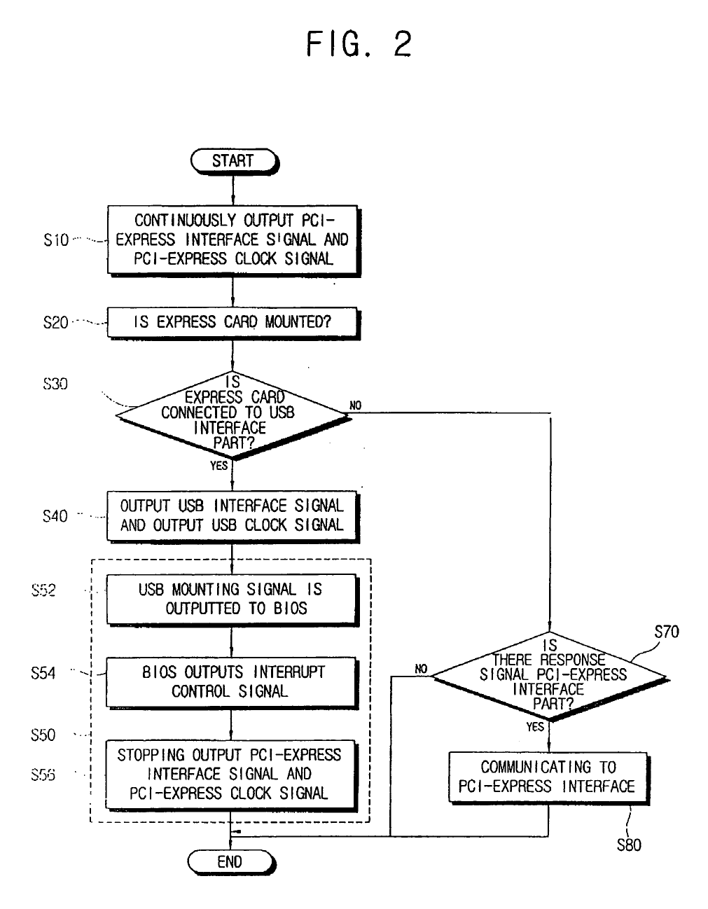

A flowchart illustrating the controlling of the computer system will be described with reference to FIG. 2. At operation S10, when the Express card 10 is not mounted into the card-mounting part 20, the ICH 50 controls the clock signal generator 30 to output the PCI-Express clock signal “PCI-E CLK”, and to continuously output the PCI-Express interface signal “PCI-E TX” to the PCI-Express interface part 24. At operation S20, the user mounts the Express card 10 into the card-mounting part 20. At operation S30, the ICH 50 determines whether the Express card 10 is connected to the USB interface part 22 according to whether the USB signal “P” from the card sensor (not shown) is inputted or not.

As illustrated in FIG. 4, when the Express card 10 is connected to the USB interface part 22 means that the USB Express card 10b supporting the USB interface is mounted to the card-mounting part 20. At operation S40, when the ICH 150 receives the USB signal “P” from the USB Express card 10b connected to the USB interface part 22, the ICH 50 controls the clock signal generator 30 to output the USB clock signal “USB CLK” to the USB interface part 22, outputs the USB interface signal “USB D+/D−” to the USB interface part 22 and communicates with the USB Express card 10b. At operation S50, the ICH 50 interrupts the output operation of the PCI-Express clock signal “PCI-E CLK” and the PCI-Express interface signal “PCI-E TX” which are continuously generated for the PCI-Express interface.

Hereinafter, the interrupting of the output of the PCI-Express clock signal “PCI-E CLK” and the PCI-Express interface signal “PCI-E TX”, will be described in more detailed. At operation S52, when the ICH 50 receives the USB signal “P” from the USB Express card 10b that is connected to the USB interface part 22, the ICH 50 outputs the USB mounting signal to the BIOS 63 to inform this connection. At operation S54, if the BIOS 63 receives the USB mounting signal and determines that the PCI-Express interface part 24 is not used, the BIOS 63 outputs the interrupt control signal to the ICH 50. At operation S56, according to the interrupt control signal, the ICH 50 controls the clock signal generator 30 so as to interrupt the outputting of the PCI-Express clock signal “PCI-E CLK” to the PCI-Express interface part 24, and interrupts the output of the PCI-Express interface signal “PCI-E TX” which is continuously generated to the PCI-Express interface part 24.

At operation S70, when the Express card 10 is not connected to the USB interface part 22 at operation S30, this is, when the PCI-Express card 10a is connected to the card-mounting part 20, the ICH 50 determines that the PCI-Express interface signal “PCI-E RX” is inputted in response to the PCI-Express interface signal “PCI-E TX”. At operation S80, as illustrated in FIG. 5, when the PCI-Express interface signal “PCI-E RX” is inputted, the ICH 50 determines that the PCI-Express card 10a is mounted into the card-mounting part 20, and communicates with the PCI-Express card 10a.

Thus, when the Express card supporting the USB interface is mounted to the card-mounting part 20 and the ICH 50 controls the USB devices (not shown) by communicating with the Express card through the USB interface, the regular clock signal and the periodical PCI-Express interface signal for the communication with the Express card supporting the PCI-Express interface are prevented from being outputted, thereby reducing wasteful power consumption while the Express card supporting the USB interface is used.

As described above, according to an aspect of the present invention, there is provided a computer system and a control method of the same that can reduce wasteful loss of electric power.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A computer system comprising:
an external card having a first interface or a second interface, to communicate with the computer system via the first interface or the second interface;
a card-mounting part to provide each of interface parts supporting the first interface and the second interface and to mount the external card;
a signal generator generating a signal for determining whether the external card supporting the first interface is mounted; and
a controller to interrupt a signal output by the signal generator when the external card supporting the second interface is mounted.

2. The computer system according to claim 1, wherein the signal generator comprises a clock signal generator outputting a clock signal to the external card mounted into the card-mounting part.

3. The computer system according to claim 2, wherein the external card comprises an Express card communicating via either a USB interface or a PCI-Express interface;
the first interface comprises the PCI-Express interface and the second interface comprises the USB interface; and
the interface parts of the card-mounting part comprise a PCI-Express interface part and a USB interface part respectively.

4. The computer system according to claim 3, further comprising a card sensor determining whether a USB Express card communicating via the USB interface is mounted into the card-mounting part;
wherein the controller prevents the clock signal generator from outputting a PCI-Express clock signal corresponding to the PCI-Express interface part and prevents an PCI-Express interface signal corresponding to the PCI-Express interface part from being outputted when the USB Express card is mounted into the card-mounting part according to a sensing signal from the card sensor.

5. The computer system according to claim 4, wherein the controller comprises an ICH (input/output control hub) to continuously output the PCI-Express interface signal to the PCI-Express interface part, and to control the clock signal generator.

6. The computer system according to claim 5, wherein the ICH outputs a USB mounting signal informing that the USB Express card is connected, and prevents the clock signal generator from outputting the PCI-Express clock signal and prevents the PCI-Express interface signal from being outputted corresponding to a predetermined control signal in the case where the USB Express card is mounted into the card-mounting part according to the sensing signal.

7. The computer system according to claim 6, wherein the controller comprises a BIOS to output an interrupt control signal preventing the output of the PCI-Express clock signal and the PCI-Express interface signal to the ICH if the BIOS receives the USB mounting signal from the ICH, and then determines that the PCI-Express interface part is not used.

8. The computer system according to claim 7, wherein the ICH controls the clock signal generator to output a USB clock signal corresponding to the USB interface part and outputs a USB interface signal corresponding to the USB interface part to the USB Express card when the USB Express card is mounted into the card-mounting part according to the sensing signal.

9. The computer system according to claim 8, wherein the card sensor comprises a predetermined signal pin outputting a card mounting signal inputted from the USB Express card to the ICH if the USB Express card is mounted into the card-mounting part, among a plurality of signal pins provided in the USB interface part.

10. The computer system according to claim 9, wherein the clock signal generator outputs either the USB clock signal or the PCI-Express clock signal according to the control of the ICH.

11. The computer system according to claim 4, wherein the card sensor comprises a predetermined signal pin outputting a card mounting signal inputted from the USB Express card to the ICH if the USB Express card is mounted into the card-mounting part, among a plurality of signal pins provided in the USB interface part.

12. The computer system according to claim 11, wherein the clock signal generator outputs either the USB clock signal or the PCI-Express clock signal according to the control of the ICH.

13. A control method of a computer system comprising a card-mounting part to provide each of interface parts supporting a first interface and a second interface and to mount an external card communicating via the first interface or the second interface, and a signal generator to generate a signal for determining that the external card supporting the first interface is mounted, the method comprising;
mounting the external card into the card-mounting part;
sensing whether the external card supporting the second interface is connected to a second interface part of the interface parts; and
preventing a signal of the signal generator from being outputted, when the external card supporting the second interface is mounted.

14. The control method of the computer system according to claim 13, wherein the external card comprises an Express card to communicate via either a USB interface or a PCI-Express interface;
the first interface comprises the PCI-Express interface, and the second interface comprises the USB interface; and
a first interface part of the interface parts comprises a PCI-Express interface parts, and the second interface part of the interface parts comprises a USB interface part.

15. The control method of the computer system according to claim 14, wherein the sensing comprises sensing whether a USB Express card communicating via the USB interface is connected to the USB interface part of the card-mounting part.

16. The control method of the computer system according to claim 15, wherein the signal generator comprises a clock signal generator outputting either the USB clock signal or the PCI-Express clock signal to the external card mounted into the card-mounting part; and
the computer system further comprises an ICH (input/output control hub) controlling the clock signal generator part to continuously output the PCI-Express interface to the PCI-Express interface part, and a BIOS; and
the preventing of the signal of the signal generator from being outputted comprises outputting a USB mounting signal to the BIOS by the ICH, when sensed that the USB Express card is mounted into the card-mounting part, and outputting an interrupt control signal to the ICH by the BIOS, when the BIOS receives the USB mounting signal and determines that the PCI-Express interface part is not used.

17. The control method of the computer system according to claim 16, wherein the preventing of the signal of the signal generator from being outputted comprises:
preventing the PCI-Express clock signal from being outputted by the clock signal generator controlled by the ICH according to the interrupt control signal, and
preventing the PCI-Express interface signal from being outputted by the ICH.

18. The control method of the computer system according to claim 17, further comprising controlling the clock signal generator to output a USB clock signal and outputting the USB interface signal , when the USB Express card is mounted into the card-mounting part as result of the sensing.

19. A computer system comprising:
a card-mounting part to mount an external card; and
a controller including a signal generator, the signal generator generating a continuous signal to the card-mounting part for determining if the external card supports a first interface,
wherein when the external card mounted to the card-mounting part does not support the first interface, the controller prevents the signal generator from generating the continuous signal to the card-mounting part.

20. The computer system of claim 19, wherein the first interface comprises a PCI-Express interface.

21. The computer system of claim 19, wherein the generated continuous signal is a PCI-Express interface signal.

22. The computer system of claim 21, wherein the controller comprises an input/output control hub (ICH) continuously generating the PCI-Express interface signal.
